(19) United States
(12) Patent Application Publication
(10) Pub. No.: US 2021/0179509 A1
(43) Pub. Date: Jun. 17, 2021

(54) FLAMELESS SMOKE COMPOSITION

(71) Applicant: KNOWFLAME, INC., Huntsville, AL (US)

(72) Inventors: R Michael BANISH, Huntsville, AL (US); Peter S. ERBACH, Huntsville, AL (US)

(21) Appl. No.: 17/137,940

(22) Filed: Dec. 30, 2020

Related U.S. Application Data
(63) Continuation-in-part of application No. 15/482,481, filed on Apr. 7, 2017, now Pat. No. 10,941,086.
Application No. 15/482,481 is a continuation-in-part of application No. 13/889,218, filed on May 7, 2013, now Pat. No. 9,617,195.
(60) Provisional application No. 61/643,565, filed on May 7, 2012.

(51) Int. Cl. C06D 3/00; C08F 2/44; C08F 22/10

(52) U.S. Cl. CPC C06D 3/00; C08K 3/36; C08F 22/1006; C08F 2/44

(57) ABSTRACT

A method and device of the present disclosure produces a non-incendiary, organic-polymerization based, smoke-producing reaction. The smoke mainly comprises thermal decomposition products of the initiator compound. A composition for the non-pyrotechnic generation of smoke is provided that includes a monomer that exothermically polymerizes, and an initiator, such that smoke is generated during a frontal polymerization reaction.

### CROSS-REFERENCE TO RELATED APPLICATIONS

This is a continuation-in-part of U.S. patent application Ser. No. 15/482,481, filed on 7 Apr. 2017 (pending). U.S. patent application Ser. No. 15/482,481 is a continuation-in-part of U.S. Pat. No. 9,617,195, filed on 7 May 2013 (issued). U.S. Pat. No. 9,617,195 cites the priority of U.S. Pat. App. No. 61/643,565, filed on 7 May 2012.

### STATEMENT OF FEDERALLY SPONSORED RESEARCH AND DEVELOPMENT

This invention was made with government support under Contract No. W911SR-11-C-0084 awarded by the United States Department of the Army. The government has certain rights in this invention.

In this context “government” means the government of the United States of America.

### BACKGROUND

Devices for producing smoke either rely on combustion or explosion (collectively “pyrotechnics”). Combustive smoke generation devices burn an organic fuel with or without an inorganic oxidizer. Examples of these smoke generation devices are thermite grenades, HC (hexachloroethane), TA (terephthalic acid), and WP (white phosphorus, or red phosphorus) smoke grenades. The reactions in these devices have large, free energies of reaction, and are by necessity highly exothermic. As such, the reactions produce dangerous levels of heat; many also produce smoke that is toxic or otherwise hazardous. The adiabatic flame temperatures of these materials can exceed 1000° C., which is one of the factors that leads to their incendiary characteristics. Such heat levels can set cloth, buildings, fuel, ammunition and other combustibles on fire. Exposure of persons to them can cause fatal burns, and inhalation of the smoke can also be fatal due to its high temperature and toxic properties.

Explosives have the same drawbacks as combustive systems, in that they generate very high temperatures and often the smoke is toxic. Explosives can also cause injury and property damage due to shrapnel and concussion.

Fog generators operate at lower temperatures by vaporizing a liquid fog solution (commonly an aqueous glycol solution). The fog solution is evaporated in heated air, then blown out through a fan. When the warm and moist air from the fog generator contacts the cooler ambient air it causes the vaporized solution to form a fog. These devices are generally safer than pyrotechnic smoke generators. However, fog generators are bulky, require a large volume of fog solution to be on hand, and require large amounts of energy (in the form of electricity) to vaporize the fog solution and to operate the fan. As a result, they are poorly suited for work in the field and are not very portable.

Consequently, there is a need in the art for a portable means to generate a smoke or fog, ideally a non-toxic and non-pyrotechnic smoke or fog that will neither poison nor burn those exposed to it.

### SUMMARY

It has been found that smoke can be generated non-pyrotechnically (without flame or explosion) through a frontal polymerization reaction (FPR). The FPR generates a small amount of heat that causes a component of the composition to form a fog or a smoke (referred to herein generally as a “smoke” for the sake of simplicity). Because the smoke is formed at relatively low temperatures, it can be safely used near people and combustible objects.

It has further been found that the addition of “excess” initiator increases the quality of the smoke and decreases the quality of the resultant polymer. Generally, during polymerization, the greater the concentration of initiator the poorer the strength of the resultant polymer, due to voids, fractures, and other defects. Without wishing to be bound to any hypothetical model, it is believed that increasing the initiator concentration beyond the minimum necessary to sustain the polymerization reaction causes an excessive number of polymerization reactions to occur simultaneously; resulting in shorter polymer chains and in a far weaker polymer product. As the initiator concentration is increased excessively, the polymer product has much shorter chains, and is far weaker. Although a disadvantage, if one wishes to produce good quality polymer, this has been found to be an advantage in the production of smoke.

In a first aspect, a composition for the non-pyrotechnic generation of smoke is provided, the composition comprising: a monomer that exothermically polymerizes upon initiation with an initiator generating a smoke; and said initiator at a mass concentration that is at least 5% the mass concentration of the monomer.

In a second aspect, a non-pyrotechnic method of generating smoke is provided, the method comprising initiating an FPR in the composition for the non-pyrotechnic generation of smoke of the first aspect, and generating smoke non-pyrotechnically.

In a third aspect, a smoke is provided that is the product of the method of the second aspect.

In a fourth aspect, a smoke is provided comprising: a decomposition product of an initiator compound.

In a fifth aspect, a non-pyrotechnic smoke generator for generating a smoke is provided, said smoke generator comprising: a support member; the composition of the first aspect supported by the support member; and a means to initiate polymerization of the monomer with the initiator; wherein the composition generates smoke via a frontal polymerization reaction once initiated.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is a functional schematic of an exemplary test performed to measure the characteristics of a smoke producing sample.

FIGS. 2A-2F show a series of photographic measurements showing the smoke density increase as increasing amounts of sample smoke-producing material are activated.

FIG. 3 is a plot of the optical density versus time for a variety of smoke producing compositions under test.

FIG. 4A is a schematic of a hypothetical mechanism of the decomposition pathway of the initiator Luperox® 231.

FIG. 4B is a schematic of a hypothetical mechanism of the decomposition pathway of the mono- and di-function monomer impurities in the commercial grade TMPTA.

FIG. 5 illustrates the results of an additional series of tests run with concentrations approaching 50 pph.

FIGS. 6A-6C illustrate the tests performed to analyze initiation of a smoke producing reaction to measure the amount of smoke produced when the reaction was initiated from the front of a smoke producing sample contained in a glass vial.

FIGS. 7A-7C illustrate the tests performed to analyze initiation of a smoke producing reaction.

FIG. 8 illustrates a plurality of cylindrical shapes tested in a series of trails of the smoke producing composition.

FIG. 9 is a photograph of a test setup from a series of tests of the smoke producing composition spread out on a section of lumber.

FIG. 10 illustrates the visible absorption spectrum of the smoke produced from the TMPTA-Luperox 231 reaction from the start of the reaction to about 20 minutes after is shown.

FIG. 11 illustrates the infrared absorption spectrum of the smoke produced from the TMPTA-Luperox 231 reaction from the start of the reaction to about 9 minutes after the reaction.

FIG. 12 depicts a “stacked disc” embodiment of a smoke generating device.

FIG. 13 depicts an embodiment of a smoke producing device comprising a substrate formed from a single sheet of material, rolled into a spiral shape.

FIG. 14 depicts a “stacked spiral” arrangement in which a plurality of spiral substrates are stacked atop one another.

FIGS. 15A, 15B and 15C depict an embodiment of a smoke producing device in which a plurality of cylindrical petals are arranged “concentrically” inside a cylindrical container that is hinged on one side.

FIG. 16 is a photograph of a pickup truck (middle) and an ATV (right) in a field prior to field testing an embodiment of the smoke generator.

FIG. 17 is a photograph of the scene in FIG. 16 during a field test of an embodiment of the smoke generator 90 seconds after the initiation of smoke generation.

FIGS. 18A-D are a time series of photographs of a field test of an embodiment of the smoke generator in a building. FIG. 18A was taken at 3 seconds after activation of the smoke generator; 18B at 6 seconds; 18C at 60 seconds; and 18D at 6 minutes.

FIGS. 19A-C are a time series of photographs demonstrating the generation of smoke using an embodiment of the smoke-generating composition on an inflammable substrate (currency).

FIG. 20. shows the results of flammability test on a roll of tissue paper.

FIG. 21 shows side-by-side images of exemplar animal test subjects, one of which was exposed to an embodiment of the smoke, and one of which was not.

FIG. 22 illustrates comparative weights (22A) and change in weight (22B) between animals that were exposed to an embodiment of the smoke and those that were not. Change in animal weight during first 48 hours following exposure (A). Mean weight values pre-exposure, 24 and 48 hours after exposure (B). Percent change in mean weights over 24 hour intervals. Values are mean±SD.

FIG. 23 illustrates weight over time for animals that were exposed to an embodiment of the smoke and those that were not. Values are mean±SD.

FIG. 24 is a table of individual animal weights when some were exposed to an embodiment of the smoke and others were not.

FIG. 25 illustrates an experimental setup that was used to test the initiation temperature of an embodiment of the smoke-generating composition. The setup includes a variable temperature hotplate, an aluminum plate with a port for a thermocouple, and approximately 10 grams of smoke generating composition as a gel with a thermocouple inserted into the center of the volume.

FIG. 26 is a time versus temperature plot of an embodiment of the smoke generating composition for a 30° C. gel temperature. The temperature of a heated aluminum plate is shown compared to the temperature of the smoke composition on the plate.

FIG. 27 is a time versus temperature plot of an embodiment of the smoke generating composition for a 50° C. gel temperature. The temperature of a heated aluminum plate is shown compared to the temperature of the smoke composition on the plate.

FIG. 28 is detail of FIG. 27 between 178-189 seconds, showing the initiation temperature of the composition during the experiment.

FIG. 29 is an embodiment of an applicator of the composition, being a caulk gun.

FIG. 30 is an embodiment of a smoke generator, being a container with an ignition wire and a volume of smoke generating composition within.

FIG. 31 is an embodiment of a smoke generator, being an unmanned aerial vehicle.

### DETAILED DESCRIPTION

The disclosure provides compositions, methods, and devices for producing smoke or fog. It is not entirely clear whether the compositions disclosed produce airborne suspensions of liquid droplets (fog) or solid particles (smoke), but for the sake of brevity the term “smoke” is used to refer to the airborne suspension. In any instance where the term “smoke appears” it should be interpreted to include a smoke or a fog (or even a mixed smoke and fog).

Various embodiments of the compositions disclosed herein may have one or more advantages over previously known smoke-producing compositions; for example: low or no flame is produced (safe to use indoors, outdoors, and in training environments with flame hazards); low toxicity of the smoke and any non-smoke residues; environmentally friendly (little to no residue or hazardous byproducts); high packing density; high smoke yield/low agglomeration of smoke particles; easily aerosolized; rapid smoke generation (short time constant); good obscuration properties in the visible portion of the electromagnetic spectrum; long smoke durations with appropriate buoyancy; and good shelf life (i.e., after mixing components, the mixture does not self-initiate and/or self-polymerize).

The smoke is created not through combustion or explosion, but by an FPR. Frontal polymerization is a process in which a polymerization reaction propagates directionally through a reaction mass because of the coupling of thermal transport and the Arrhenius-dependence of the kinetics of an exothermic reaction. In FPRs, the components are premixed, but stable until initiated by an external source. This is unlike other systems, such as a 2-part epoxy: as soon as the two components are mixed, an exothermic reaction is initiated. As another example, RTV type polymers will self-initiate once exposed to oxygen. The reactions developed here operate differently than either of these or similar types of examples.

FPR is a form of self-propagating high-temperature synthesis (SPHTS). Here the term “high-temperature” is used to indicate higher than ambient temperature, but certainly lower in temperature than pyrotechnic smoke generation. In FPR as in the case of SPHTS the system will not start reacting until sufficient energy is applied to the material to get a reaction front propagating through the system. This self-propagating wave moves rapidly through the system so long as sufficient heat is generated at the propagation front. Thus, these systems are inherently stable until enough energy is added to start the reaction. Materials with high heat capacity can be incorporated into the mixture to moderate the reaction. Thus, the system can be tuned such that the heat released does not lead to excessive heating (or burning) of the surrounding environment, thereby reducing incendiary hazards. For example, the addition of filler materials has the effect of reducing the front temperature and thereby reducing the incendiary hazard by diluting the concentration of monomer and initiator and by raising the specific heat of the composition.

### I. DEFINITIONS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

### II. COMPOSITIONS THAT GENERATE SMOKE

In a general embodiment, the composition comprises a monomer that exothermically polymerizes upon initiation with an initiator to generate a smoke, and the initiator itself present at a mass concentration that is at least 5% by weight the mass concentration of the monomer.

Without wishing to be bound by any hypothetical model, it is believed that the smoke is mainly thermal decomposition products of the initiator. It is further believed that the exothermic polymerization of the monomer generates sufficient heat to volatilize the thermal decomposition products of the initiator.

Since the initiator is the source of the smoke in this embodiment, it is only necessary to have a sufficient reaction temperature to sustain the initiator decomposition reaction and maintain the FPR. Conventional smoke generation involves the combustion of a fuel (often with an oxidizer) that vaporizes a separate component that forms the smoke. Since the smoke created by polymerization of embodiments of the present smoke generating composition is composed of the initiator itself, an additional component is not strictly necessary (although it may be included in some embodiments). Without wishing to be bound by any hypothetical model, it is believed that the monomer itself may also decompose to form part of the smoke in some embodiments.

In some embodiments of the composition, the reactants have reaction temperatures in the range of up to 400° C. In further embodiments, the reaction temperature ranges up to 300° C. Such temperatures can be measured by providing the composition in a generally flat sheet or strip on a heated plate, as explained in more detail in the examples below.

Various embodiments of the composition contain reactants that create smoke under conditions that differ significantly from pyrotechnic methods. For example, the reactants may react to create smoke wherein the reaction is flameless, nonexplosive, requires no O₂, consumes no O₂, and any combination of two or more of the foregoing. In a specific embodiment of the composition, O₂ is not a reactant in the exothermic reaction. Some such embodiments may have the advantage of producing smoke when in low-O₂ environments, such as underwater. Furthermore, other oxidants might not be required. Oxidants that are used in pyrotechnic applications include inorganic and organic forms of chlorate, perchlorate, nitrate, sulfate, permanganate, chromate, peroxide, and oxide. Commonly used cations include sodium, potassium, barium, ammonium, strontium, lead, cesium, bismuth, iron, and manganese. Some embodiments of the composition lack any significant amount of one or more inorganic oxidizers. The “significant amount” can mean no more than 10% w/w. Some embodiments of the composition contain no more than 10%, 9%, 8%, 7%, 6%, 5%, 4%, 3%, 2%, 1%, 0.5% and 0.1% w/w of one or more of a chlorate, perchlorate, nitrate, sulfate, permanganate, chromate, an inorganic peroxide, and an inorganic oxide.

In experimental testing of the smoke producing composition of the present disclosure, it was found that increasing the amount of initiator in the compound increased the amount of smoke produced. The composition may have a w/w ratio of initiator:monomer of at least 5% (i.e., 5 g of initiator per 100 g of monomer). Various embodiments of the composition may have higher w/w ratios of initiator:monomer, such as 10, 20, 50, 60, 70, 75, 80, 85, 90, 95, 99, 100, 110, 120, 130, 140, 150, 160, 170, 180, 190, 200, 300, 400, 500, 600, 700, 800, 900, 1000, 1500, 2000, 2500, 3000, 3500, 4000, 4500, 5000% and at least any of the foregoing ratios. In further embodiments, the w/w ratio of initiator:monomer is no more than 2500%.

Without wishing to be bound by any hypothetical model, it is believed that the monomer provides heat (through exothermic polymerization) to vaporize the smoke components. The monomer may be one that is suitable to participate in an FPR, such as a trifunctional monomer, having three double-bond carbon ends associated with each monomer molecule. Some preferred embodiments of the composition contain a triacrylate monomer. Specific examples of triacrylate monomers potentially suitable in the composition are trimethylolpropane triacrylate (TMPTA), glycerol propoxylate (1-PO/OH) triacrylate (GPOTA), and trimethylpropane propoxylate triacrylate (TMP(PO)TA). Combinations of such monomers could potentially be used as well. Note that the monomer may also be a material with a backbone other than carbon; for example, the silicon backbone in silicone caulk or RTV sealant. In addition, the production of a polymer is not a strict necessity, so long as an exothermic polymerization reaction occurs.

Some embodiments of the composition contain an additional component that forms the smoke. Components such as methyl benzoate, benzyl benzoate, and pentyl acetate, also increase smoke production, but reduce buoyancy. These materials are esters used as food additives and have the advantages of low toxicity.

The initiator functions to initiate the polymerization of the monomer when sufficient energy is introduced. One suitable class of initiators is organic peroxides. Specific examples of organic peroxide initiators include di-tert-butyl peroxide, tert-butyl peroxybenzoate, tert-butyl hydroperoxide, and cyclohexyl hydroperoxide. The composition may contain one or more of the foregoing, alone or in combination.

The specific heat and/or concentration of monomer and initiator can be modulated by the addition of a “filler.” The filler does not participate in the FPR, and may be a generally unreactive compound. Suitable fillers include fumed silica, kaolin powder, powdered sugar, and any combination of two or more of the foregoing. Fumed silica has the advantages that the mass required is low, and a high area-mass ratio provides significant thickening with a low thermal mass. The filler should be present at a concentration sufficient to achieve propagation of the FPR at a controlled rate—preventing the monomer from polymerizing too quickly (producing excessive heat) while allowing the production of sufficient heat for polymerization. For example, some embodiments of the composition contain at least 2% w/w filler. Further embodiments contain at least 5% w/w filler. Various embodiments of the composition may have higher w/w ratios of initiator:filler, such as 10, 20, 50, 60, 70, 75, 80, 85, 90, 95, 99, 100, 110, 120, 130, 140, 150, 160, 170, 180, 190, 200, 300, 400, 500, 600, 700, 800, 900, 1000, 1500, 2000, 2500, 3000, 3500, 4000, 4500, 5000% and at least any of the foregoing ratios. In further embodiments, the w/w ratio of initiator:filler is no more than 2500%. More specific embodiments of the composition contain 5-10% w/w filler. A specific embodiment of the composition contains 5-10% w/w fumed silica.

The combination of the monomer, initiator, filler, and other components will contribute to the initiation temperature, when thermal initiation is used. The “initiation temperature” is the temperature to which the composition must be raised locally (in one particular area) in order to start the FPR, when thermal initiation is used. In some embodiments of the composition, the initiation temperature is no more than 160° C. In further embodiments of the composition, the initiation temperature is no more than 130° C. In further embodiments of the composition, the initiation temperature is no more than 140° C. In more specific embodiments of the composition, the initiation temperature is 100-160° C. In further specific embodiments of the composition, the initiation temperature is 120-130° C. In further specific embodiments of the composition, the initiation temperature is 120-140° C. These initiation temperatures have the advantage of being well below the flashpoints of many common construction materials, meaning that thermal initiation can be achieved without the use of a dangerously hot heat source. In addition, some embodiments of the composition produce smoke without flame or explosion, in which case even low flashpoint materials will not ignite. For example, some embodiments of the composition have a measured flashpoint of only 102° C., yet do not burn during smoke production presumably because there is no local open flame. Initiation temperature can be measured by any suitable method, including by providing the composition on a heated plate as described in the examples below. In alternative embodiments, photoinitiation is used by directing a light source of sufficient intensity to trigger initiation on the composition.

The combination of the monomer, initiator, filler, and other components will contribute to the temperature the composition reaches during the FPR and/or during the generation of the smoke. Some embodiments of the composition will not exceed a given maximum temperature during the FPR and/or during the generation of the smoke. In some such embodiments, the composition does not exceed 300° C. during the FPR and/or during the generation of the smoke.

An infrared-opaque agent may be included in the composition to increase the opacity of the smoke in the IR spectrum. Ideally the IR-opaque agent will be at least partially soluble in the composition and will migrate into the smoke. Some embodiments of the IR-opaque agent are: methyl benzoate, benzyl benzoate, pentyl acetate, and any combination of two or more of the same.

Some embodiments of the composition are translucent or transparent over at least a portion of the infrared spectrum. This has the advantage of preventing the smoke from obscuring the use of IR cameras. Some embodiments of the composition generate smoke that is translucent or transparent over at least a portion of the infrared spectrum that includes λ=1.4 μm.

The composition can be formulated in various physical states. These states include a solid, a liquid, and a gel (among others). Some embodiments of the composition are semisolid, such as a slurry, a paste, a colloid, a slime, or a gel. Further embodiments of the composition are nonfluid, for example a solid. A solid or semisolid has the advantage of preventing convection during the FPL, and may be formed to allow more controlled propagation of a frontal polymerization reaction.

Non-fluid embodiments and some semisolid embodiments of the composition may be manufactured with a defined shape. For example, a sheet is especially useful if an FPR is desired. Suitable sheets may be created as strips, discs, spirals, tapes, and other shapes in which the first dimension (e.g., height) is much smaller than at least one of the other two dimensions. Such flat shapes allow the formation of a reaction front that spreads along only one or two axes.

Fluid embodiments of the composition could potentially be used by dispensing a controlled amount to an initiation mechanism to produce smoke at a controlled rate.

An initiation mechanism may be present in the composition. The initiation mechanism provides sufficient energy to initiate polymerization, in the form of heat, electromagnetic radiation, or other forms. Some embodiments of the initiation mechanism are a heat source. The heat source may be a non-pyrogenic heat source. Embodiments of the non-pyrogenic heat source may be a conductive wire connected to a source of electric current, a heated gas, a source of electromagnetic radiation, a solid heat conductor, a nichrome wire loop connected to an electric power source, a heat gun, a soldering iron, focused light, a piezoelectric device, and a combination of the foregoing. One exemplary embodiment of the initiation device is a 1″ conduction loop of 30 gauge nickel-chromium (NiCr, or nichrome) wire with a resistance/unit length of approximately 0.5 Ohm/in. Testing has shown that a current draw of approximately 1 Amp is sufficient to initiate the FPR is some embodiments of the composition. Using Power, P=I2R, where I is the current in Amps and R is the resistance in Ohms, this yields an input Power of P=(1 Amp)2(0.5 Ohm)=0.5 W.

The primary mixture components of the smoke producing composition also have enough thermal conductivity that, if a point ignition source is applied, the bulk mixture reactants may quickly convect the required reaction energy away from the reaction site and cause the reaction to quench itself. The very low thermal conductivity of fumed silica “insulates” the reaction region, preventing the heat of reaction or of initiation from convecting away too rapidly. When no filler is present, a large area heat source, such as a heat gun, may be required to inject significant heat into the mixture to overwhelm the convective heat losses. Present experimentation has shown cases where, for all other mixture components held constant, increases in filler (fumed silica) have resulted in a higher absorption smoke. The filler may provide more nucleation sites for polymerization to initiate.

A preferred embodiment of the composition comprises glycerol propoxylate triacrylate (as the monomer), and tert-peroxybenzoate (as the initiator) present at a mass concentration that is 5-20 times the mass concentration of the monomer.

Another preferred embodiment of the composition comprises tert-peroxybenzoate (as the initiator) at 100 parts by weight, at least 4 parts by weight TMPTA (as the monomer), and at least 4 parts by weight fumed silica (as the filler).

### III. METHODS OF GENERATING AND USING SMOKE

A non-pyrotechnic method of generating smoke is provided, comprising initiating a frontal polymerization reaction in a composition for the non-pyrotechnic generation of smoke, and generating smoke. The composition may be any of the smoke-generating compositions disclosed above. Because the smoke is generated by an FPR, in at least some embodiments of the method the smoke is not produced by combustion. Furthermore, in at least some embodiments of the method the smoke is generated non-explosively. It is preferred that the method involves the non-pyrotechnic generation of the smoke, involving neither flame nor explosion. As discussed above, such embodiments may have the advantage of generating the smoke without O2 being a reactant in the smoke generating reaction. In some embodiments of the method, no inorganic oxidizer is a reactant in the smoke generating reaction. Consequently, in such embodiments of the method O2 is not consumed while smoke is generated.

Without wishing to be bound by any hypothetical model, it is believed that the method generates smoke that mainly comprises (at least 50% w/w) the thermal decomposition products of the initiator. Some embodiments of the method will generate smoke that is 75%, 80%, 85%, 90%, 95%, or 100% thermal decomposition products of the initiator.

The method comprises initiating the FPR. If thermal initiation is used, the initiating step comprises heating the composition of any one of the claims above to an initiation temperature suitable to initiate polymerization of the monomer with the initiator. This heating must be localized if an FPR is desired, as heating the entire composition to the initiation temperature would result in the entire composition polymerizing simultaneously. The localized heating can be at a point, along a line, over a relatively small region, or using a similar approach. Some embodiments of the method have the advantage of requiring relatively low temperatures for thermal initiation. In some such embodiments initiation can be accomplished by locally heating the composition to a temperature of no more than about 200° C. In further such embodiments the initiation is accomplished by heating the composition to a temperature of 100-200° C. In still further embodiments the initiation is accomplished by heating the composition to a temperature of 100-160° C. In still further embodiments the initiation is accomplished by heating the composition to a temperature of no more than about 130° C.

Thermal initiation can be accomplished using any of various heaters. For example, thermal initiation could be accomplished by running an electric current through an electrically conductive material in contact with the composition. In a preferred embodiment the conductive material is a nickel-chromium wire. The power source can be as simple as a 9 V battery. The heat source can also be a thermally conductive material in contact with the composition, where the thermally conductive material is in contact with a heater.

Some embodiments of the method have the advantage of producing smoke at low temperatures. In some embodiments of the method the composition does not exceed 300° C. during the generation of the smoke. In some such embodiments the smoke itself may not exceed 300° C.

Some embodiments of the method comprise generating smoke in an environment in which pyrotechnic smoke generation would be dangerous or impractical. Examples of such environments include: low-O₂, anoxic, underwater, indoors, in a vehicle, and in close proximity (such as within 3 m) to a living subject (such as a mammal).

### IV. SMOKE

A smoke is provided. As described above, the smoke comprises a decomposition product of an initiator that participated in a polymerization reaction. More specific embodiments of the smoke comprise a decomposition product of an initiator from an FPR. The decomposition product may be, for example, a thermal decomposition product. The initiator from which the decomposition product is derived may be any described above as suitable in the composition.

The smoke may be produced by any of the methods described above.

The smoke will in some cases be opaque in the visible spectrum. Visual opacity has the advantage of allowing the dispersal of the smoke to be easily monitored. The smoke may also be opaque in the infrared spectrum, which has the advantage of allowing the dispersal of the smoke to be monitored using infrared sensors. Alternatively, the smoke may be non-opaque in at least part of the infrared spectrum, to allow IR cameras and sensors to function unhindered during its use. In a specific embodiment the smoke is non-opaque over at least part of the infrared spectrum that includes X=1.4 μm; this is a wavelength at which many infrared cameras are sensitive. If infrared opacity is desired, the smoke may comprise an infrared-opaque agent, such as any listed above as suitable for use in the composition.

### V. SMOKE GENERATION DEVICES

The composition finds use in a non-pyrotechnic smoke generator. A general embodiment of the device comprises a support member having a length and a width; the composition of any one of the claims above supported by the support member; and a heat source positioned to heat the composition.

The heat source can advantageously be non-pyrotechnic, such as a source of electric current, a heated gas, a solid heat conductor, or a radiation source. Some embodiments of the device may use a pyrotechnic heat source to trigger the otherwise non-pyrotechnic reaction. Examples of pyrotechnic heat sources include a fuse and a flame. In a specific embodiment, the heat source is a wire in contact with the composition and connected to a source of electric current. In a further specific embodiment the heat source is a nickel-chromium wire connected to a source of electric current. The heat source may be configured to limit the temperatures generated into a relatively safe range. In some such embodiments of the device the heat source is configured to generate a temperature of no more than about 200° C. In further such embodiments of the device the heat source is configured to generate a temperature of 100-200° C. In still further such embodiments of the device the heat source is configured to generate a temperature of 100-160° C. In a specific embodiment of the device the heat source is configured to generate a temperature of no more than about 130° C.

The support member may be dimensioned to modulate the duration of the FPR of the composition. One way this can be accomplished is by providing a support member that is longer in one dimension than another (i.e. the ratio of the length to the width is more than about 1:1). Because an FPR generally spreads in all directions at about the same rate, the support member becomes more efficient in terms of duration of the FPR per unit mass when it is longer and thinner. Various examples of such configurations include: a support member that is a spiral, and in which the ignition wire contacts the spiral at the center of the spiral or the edge; a support member that is a coiled strip, and in which the ignition wire contacts the support member at the center of the coil or the edge of the coil; multiple support members each being a coiled strip, and in which the ignition wire contacts each of the said support members at the center of the coil or the edge of the coil; multiple support members, each having the shape of an arc of an open cylinder, and contacting the other support members along a line of contact from the top to the bottom of the cylinder, wherein the ignition wire runs along the line of contact.

Other shapes of the support member can be used to modulate smoke production as needed. For example, when the support member is a disc, and the ignition wire contacts the center of the disc, smoke will be produced at an accelerating rate as the front of the FPR expands as a circle of increasing circumference.

The support member functions to hold the smoke generating composition and provide it with shape. In a specific embodiment, the support member comprises a fibrous matrix onto which the composition is deposited (e.g., coated). In some such embodiments the smoke generating composition occupies a significant portion (at least 25% v/v) of the interstices in the matrix. In further embodiments the composition may occupy more specific portions of the interstitial volume of the matrix, for example at least 30, 35, 40, 45, 50, 55, 60, 65, 70, 75, 80, 85, 90, 95, 99, or 100% v/v. The matrix itself may comprise fibers of various compositions, such as polymer fibers, natural fibers, metallic fibers, and ceramic fibers. The matrix could also comprise one or more wires that serve as the heat source (“ignition wires,” although nothing is ignited).

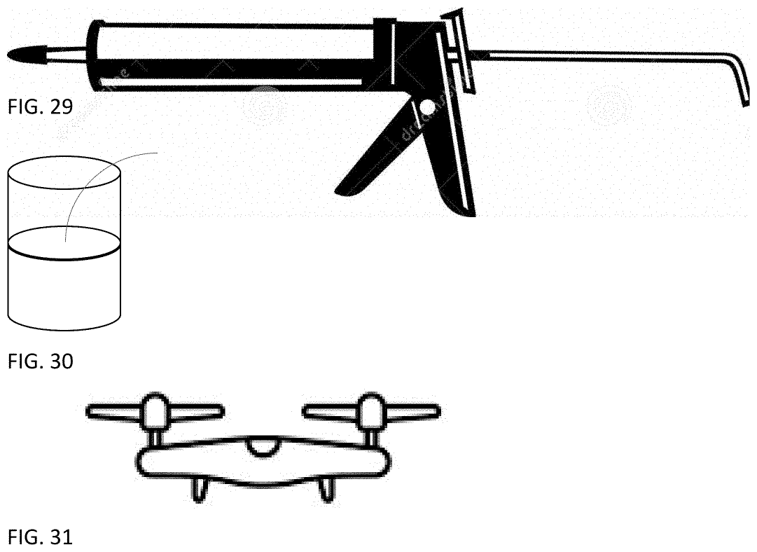

The smoke can be generated by simply applying a line of solid or semi-solid smoke generation composition on a surface. The FPR can be initiated at one end of the line or at a location in the middle (in which case the FPR will proceed in two directions). The semi-solid smoke generation composition may take the form of a conventional caulk gun (FIG. 29) loaded with the smoke generation composition.

Some embodiments of the smoke generator take the form of other more conventional smoke generators, such as a grenade, a handheld grenade, a rifle grenade, a 40 mm grenade, and a 66 mm vehicle-launched grenade. Further embodiments take the form of a container with an ignition wire and a volume of smoke generating composition within (FIG. 30), and an unmanned aerial vehicle containing a volume of the smoke generating composition and a means to initiate the FPR (FIG. 31).

Some embodiments of the smoke generator comprise only non-metal parts in contact with the smoke generating composition. Such embodiments may comprise a peroxide initiator. Without wishing to be bound by any hypothetical model, is it possible that the presence of metal in contact with a peroxide initiator could corrode the metal or have other unwanted effects. Further embodiments of the generator comprise only non-metal parts in contact with the smoke as well.

### VI. EXAMPLES

A series of preliminary experiments were conducted with initiator concentrations from 1 to 15 pph (parts per hundred of monomer). These preliminary tests qualitatively indicated that higher initiator concentrations resulted in increasing smoke yields. These tests also indicated that high initiator concentrations did not adversely affect the rate of the polymerization process and that sufficient heat was generated for the initiator to decompose into a visible smoke.

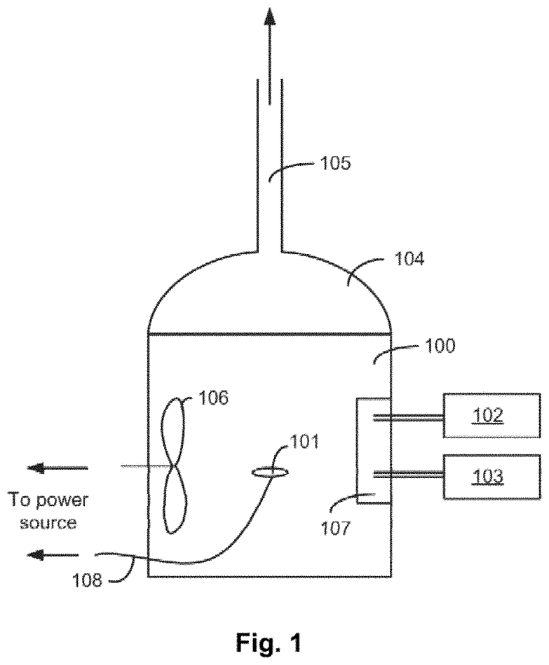

FIG. 1 is a functional schematic of an exemplary test performed to measure the characteristics of a smoke producing sample 101 in a chamber 100. The chamber 100 was substantially one (1) cubic foot in volume (11″×12″ by 10″). Specifically, a Fisher Scientific® Dry Box was used as an airtight chamber 100 in this test. An FP reaction of the sample 101 was remotely initiated via a wire 108 extending through the chamber wall and to a power source (not shown). A fan 106 inside the chamber 100 circulated the smoke (not shown) produced by the reaction. Visible spectra measurements were taken with an Ocean Optics HR2000 UV-Vis spectrometer 102. The optical cell (not shown) was a Starna 34-SOG-100 10 cm cell. Infrared spectra were determined with a Nexus470 FTIR 103 using a 4″ pathlength cell (not shown) with KBr windows (not shown).

The chamber 101 comprised a transparent window 107 to allow visual access to the sample under test for viewing the smoke and measuring smoke parameters. A vent hood 104 collected fumes from the test and a vent 105 vented fumes outside of the building.

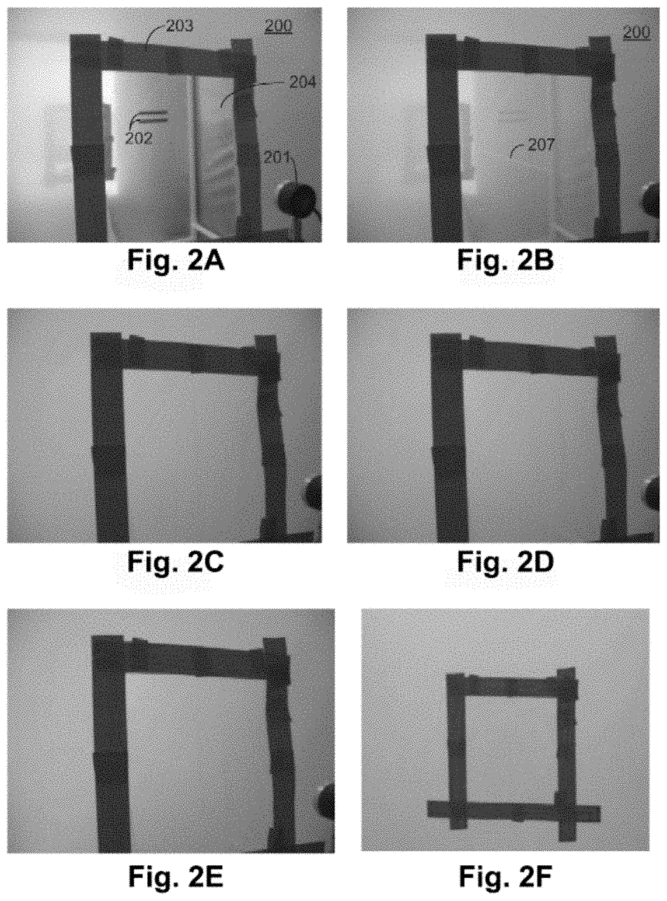

In a similar test of the smoke producing sample, a 50 ft3 PVC and plastic wrapped chamber (not shown) was constructed. Two clear plastic windows 204 (FIG. 2A) on the chamber 200 (FIG. 2A) provided for optical measurements and visualization of the smoke production.

A series of experiments were completed in both the 1 ft3 and 50 ft3 chambers to test the limits of smoke production with increasing initiator concentration. Measurements of smoke production versus initiator concentration from 5 to 50 pph have been made in the 1 ft3 chamber and from 5 to 25 pph in the 50 ft3 chamber. For tests in both the 1 ft3 and 50 ft3 chambers, optical transmission measurements (I/I0) were made versus time using a 633 nm laser and Newport laser power meter. From these tests it was determined that increasing the initiator concentration to at least 25-30 pph gave a good smoke production reaction, and that increasing to 50 pph would continue to produce more smoke. Tests were run to quantify the amount of material necessary to produce a dense enough smoke for obscuration. A series of tests using different sample weights with 25 pph starting material versus optical density were run in the 50 ft3 chamber. The amount of material was increased from 5 to 25 grams of monomer (all with 25 pph of initiator); this corresponds to 0.1 to 0.5 grams of monomer per ft3 of chamber volume.

FIGS. 2A-2F show a series of photographic measurements showing the smoke density increase as increasing amounts of sample smoke producing material are activated. A laser power meter 201 measured optical transmission of smoke in the chamber 200. Tape 203 defined a rectangular transparent window 204. Two tape strips 202 were mounted horizontally on the opposite inside side wall of the chamber. As can be seen in FIG. 2A, which illustrates the chamber 200 before a smoke producing reaction is initiated, the tape strips 202 are clearly visible through the window 204. However, as smoke concentration increases, as shown in FIG. 2B in which the smoke density is 0.10 grams monomer per cubic foot, the tape strips 202 become less visible. The beam 207 from the laser power meter 201 is clearly visible in FIG. 2B.

In FIG. 2C, which illustrates a smoke density of 0.15 grams monomer per cubic foot, the tape strips 202 are invisible. In FIG. 2D, the smoke density is 0.20 grams monomer per cubic foot. In FIG. 2E, the smoke density is 0.25 grams monomer per cubic foot. In FIG. 2F, the smoke density is 0.30 grams monomer per cubic foot.

It is notable that the testing illustrated in FIGS. 2A-2F was performed indoors in plastic containment chambers. This highlights the non-incendiary characteristic of the reaction. The smoke does have an odor to it, so the chamber needs to be vented outside. However, an unpleasant odor could be advantageous in some situations where a “stink bomb” might be desired.

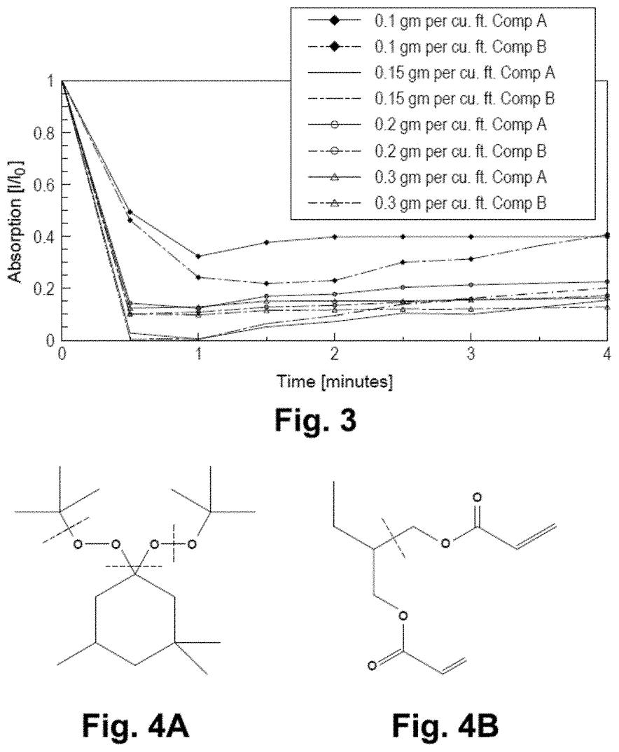

FIG. 3 is a plot of the optical density versus time for the same mass of materials from testing performed in 50 ft3 chamber. This figure shows that after about 0.15 grams of starting monomer per cubic foot (g/ft³), the optical density drops below 0.1. Comparing the results of FIG. 2C with FIG. 3 at 0.15 g/ft³ the smoke density is almost sufficient to totally obscure the reference tapes 202 (FIG. 2C) on the opposite wall. As the sample mass increases up to 0.3 g/ft³ the smoke density and its obscurant ability clearly increase.

The photographic series FIGS. 2A-2F illustrates a quirk of the laser beam visibility: with increasing smoke density, the laser beam 207 actually seems brighter and more visible. This result is also shown in the data of FIG. 3. The measured optical density for starting sample mass of greater than 0.15 g/ft³ is actually greater than for 0.15 g/ft³ itself, while it is clear from the photographs in FIG. 2C-2F that the smoke is denser. This higher measured optical density is likely due to a multiple scattering phenomenon competing with the initial beam absorption/scattering. Note also from FIG. 3 that the duration of the smoke (at least in this controlled environment, i.e., in the absence of driving winds) is considerable.

### Decomposition Products

The starting monomer and initiator in the exemplary testing was TMPTA and Luperox® 231. The expected decomposition products have been analyzed both through a literature review, and via Gas Chromatograph-Mass Spectrometer (GC-MS) analysis of the smoke products. The literature review lists as the decomposition products:
a. 3,3,5-trimethylcyclohexane,
b. 2,4,4-trimethylcyclohexane,
c. Trimethylcyclopentane
d. t-butyl alcohol,
e. acetone,
f. methane, and
g. carbon dioxide.

Experimental GC-MS analysis essentially confirmed the literature results, but showed only three components in the smoke:
h. 3,3,5-trimethylcyclohexane,
i. 2,4,4-trimethylcyclohexane, and
j. t-butyl alcohol.
   Neither acetone nor trimethycyclopentane were detected. The molecular weights and melting and boiling points of some of the decomposition components are listed in Table 2 below. Acetone and Tert-butyl alcohol are gases at room temperature, and the trimethylcyclohexane is liquid droplets at room temperature.

TABLE 2
Molecular weights and melting and boiling points of
Luperox ® 231 decomposition products

| Decomposition | Molecular | Melting | Boiling |
|---|---|---|---|
| Product | Weight | Point | Point |
| Vapor Species | [g/mole] | [° C.] | [° C.] |
| 1,3,5-trimethylcyclohexane | 126.24 | −49.7 | 138.5 |
| Acetone | 58.08 | −95 | 56.2 |
| Tert-butyl alcohol | 74.12 | 25.2 | 82.2 |

FIG. 4A is a schematic of the decomposition pathway of the Luperox® 231, and FIG. 4B is a schematic of the decomposition pathway of the mono- and di-function monomer impurities in the commercial grade TMPTA. In this schematic, dotted lines are cleavage.

From the GC-MS analysis of the smoke produced, the reaction products are trimethylcyclohexane and t-butyl alcohol. The reaction products of the monomer decomposition are not seen in the smoke but may affect its infrared absorption properties.

### Total Sample Mass Loss During Smoke Production

A series of tests were performed to measure the mass loss of the sample smoke generation compound versus the amount of initiator used in the compound. These tests were performed to confirm that the majority of the initiator was decomposing, and this expectation was confirmed. For the higher initiator concentrations and for thin (<⅛″) sample thickness, there was more mass loss than just the initiator itself. The significance of sample thickness is discussed further below.

A series of tests was also performed to determine the mass loss over a wider initiator concentration range, and the initiator concentration was varied from 1 pph to 30 pph. The fumed silica (thickening agent) content was held constant at 10 pph. The starting TMPTA monomer was 2 grams and the mass of the initiator was varied from 0.02 to 0.60 grams. Two to three samples were run for each mixture composition. The results of these tests are presented in Table 3 below.

TABLE 3
Percent mass loss of monomer-initiator-filler mixtures
versus the initial initiator concentration.

| | Initiator Concentration [parts per hundred] | | | | |
|---|---|---|---|---|---|
| | 1 | 5 | 10 | 20 | 30 |
| Percent mass loss | 0.5-1 | 4.0-5.2 | 9.8-13.4 | 22-32 | 33-49 |
| (number of samples) | (2) | (3) | (3) | (3) | (2) |

As can be seen from Table 3, from about 1 to 5 pph of initiator, the mass loss was approximately proportional to the amount of initiator added. At higher initiator concentrations (greater than 10 pph) the total mass loss was greater than the initiator mass, possibly due to a decomposition of mono-functional, and di-functional “impurities” that are present in the commercial grade TMPTA, or due to a decomposition of the tri-functional TMPTA itself.

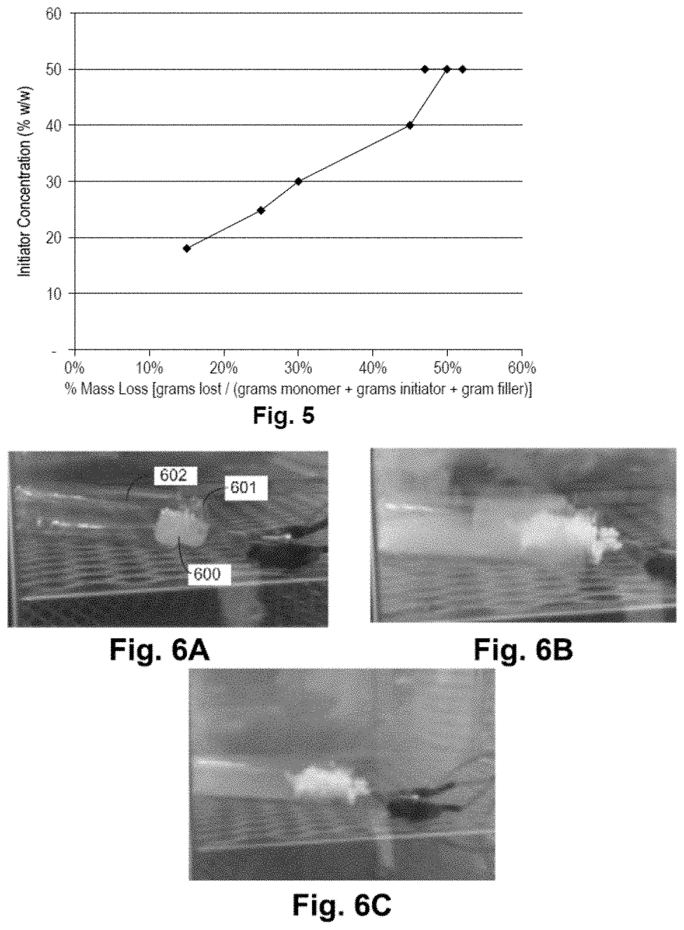

FIG. 5 illustrates the results of an additional series of tests run with concentrations approaching 50 pph.

The internal temperature of 5 gram samples of the mixed compound was measured in order to better understand the safety, and non-incendiary characteristics of the FPR. In initiator concentrations of less than 5 pph, the internal sample temperature was 100-200° C. At initiator concentrations from about 15 to 30 pph, the internal temperature increased to 300-350° C.

### Effect of Sample Layer Thickness and Geometry on Smoke Production

A series of tests was performed to determine the effect of aspect ratio (width v. length at fixed heights) of the sample versus the amount of smoke produced. These tests were conducted under three testing/operating scenarios: 1) front and rear initiation of the reaction; 2) cylindrical samples of varying aspect ratio, initiated from the top “free” surface; and 3) rectangular samples of varying aspect ratios. Test geometries 1) and 2) were conducted in the one ft³ test chamber, and the third series of tests were conducted in the 50 ft³ chamber. The sample smoke producing compound was 10 pph Luperox® 231 and 10 pph fumed silica filler.

### Tests of Front Versus Rear Reaction

FIGS. 6A-6C illustrate the tests performed to analyze initiation of a smoke producing reaction to measure the amount of smoke produced when the reaction was initiated from the front, expanding portion, of the sample contained in a glass vial. In FIG. 6A, the sample 600 is disposed near an open front end 601 of a glass vial 602. In FIG. 6B, the sample 600 has just been ignited. FIG. 6C is a wider view of the sample 600 after the smoke has expanded. The smoke was close to neutrally buoyant and filled the test chamber in an amount that would be expected, given the size of the sample.

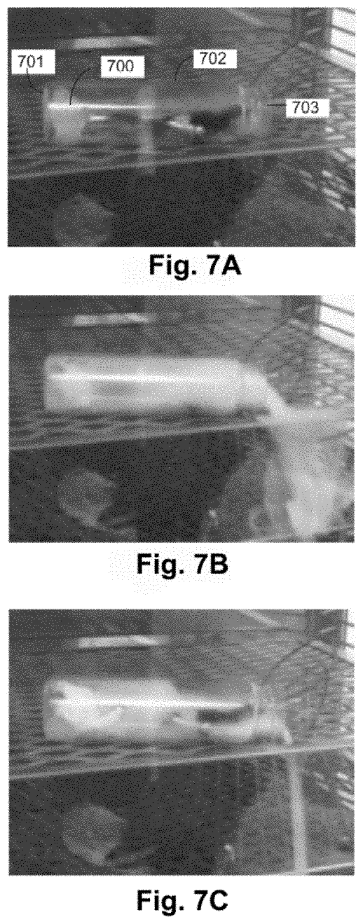

FIGS. 7A-7C illustrate the tests performed to analyze initiation of a smoke producing reaction to measure the amount of smoke produced when the reaction is initiated from a sample disposed in the rear, constrained, portion of a glass vial. In FIG. 7A, the sample 700 is disposed near the rear end 701 of a glass vial 702. In this series of tests, as shown in FIGS. 7B and 7C, any hot smoke vapors have to travel through the unreacted portion of the sample before reaching the open end 703 of the vial 702. The resultant smoke was denser than the surrounding air and tended to sink to the bottom of the test chamber. In both of the tests illustrated in FIGS. 6 and 7, the FPR proceeded to completion.

### Tests of Cylindrical Samples of Varying Aspect Ratios

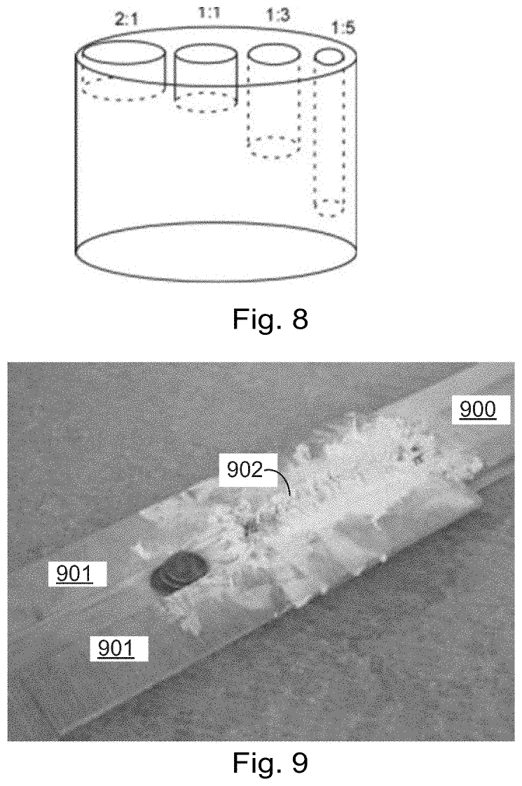

The second series of trials tested a constant volume of material in three cylinder shapes with bores of different aspect ratios, 2:1, 1:1, 1:3, and 1:5, as illustrated in FIG. 8. The cylinder bores were generated by drilling holes in a Delrin puck. A syringe was used to place the samples in the bore holes. These tests showed that the 2:1 aspect ratio sample had the most smoke production; the 1:3 and 1:5 aspect ratio tests produced a minor amount of smoke. The 2:1 aspect ratio test produced a typical amount of smoke. The test results are reported in Table 4 below. In each of these tests, the reaction was initiated at the top of the sample with enclosed sides and bottom. The conclusion from these tests is that a low aspect ratio of height to diameter is desirable.

TABLE 4
Optical transmittance of smoke produced for
various aspect ratio cylindrical samples

| Sample Aspect Ratio | Sample Diameter | Optical Transmittance |
|---|---|---|
| [diameter to height] | [inches] | [I/I0] |
| 2:1 | 1 | 0.20 |
| 1:1 | ⅝ | 0.8 |
| 1:3 | ½ | 0.97 |
| 1:5 | ¼ | 1.0-no signal loss |

### Tests of Rectangular Samples of Varying Aspect Ratios

FIG. 9 is a photograph of a test setup conducted with 10 gram samples (20 pph initiator, pph silica), spread out on a section of lumber 900. Selected thickness lumber guide rails 901 were spaced about one inch apart, the guide rails were varied from 3/16″ in height, to ¼″ in height to ½″ in height, and the sample 902 (shown after the reaction) was spread out to roughly 1.5 to 4 inches long between the guide rails. Note that the FIG. 9 lumber shows no signs of combustion although it has been used for several dozen tests. The measured optical density values are given in Table 5 below. These results confirm that the layer thickness plays a critical role in the efficiency of smoke produced.

TABLE 5
Optical transmittance measurements versus aspect ratio
and sample thickness for fixed mass samples.

| | Sample | Sample | |
|---|---|---|---|
| Sample Aspect Ratio | Thickness | Length | Optical Transmittance |
| [height to length] | [inches] | [inches] | [I/I0] |
| 1:20 | 3/16 | ~4 | 0.10 |
| 1:12 | ¼ | ~3 | 0.25 |
| 1:3 | ½ | ~1.5 | .98-no signal loss |

Test with Monomers and Initiators Other than TMPTA and Luperox® 231

A series of tests were conducted with TMPTA and initiators other than Luperox® 231 and tests of monomers other than TMPTA to confirm that the smoke production was due to the decomposition of the Luperox® 231 and to confirm the effectiveness of TMPTA as the monomer. These tests were only run for qualitative, rather than quantitative smoke production assessment. The mixture composition was 10 pph initiator and 10 pph fumed silica. Table 6 shows the results of these tests.

TABLE 6
Monomer-Initiator combinations tested for
their qualitative smoke production ability.

| | Initiators | |
|---|---|---|
| Monomers | Luperox ® 231 | t-butyl peroxybenzoate |
| TMPTA | Good smoke-Control | Similar to Control |
| (Trimethylolpropane | sample | |
| triacrylate) | | |
| TMPTA + dibutyl | Good or better | No Test |
| phthalate | smoke-smoke sinks | |
| PETA | Poor smoke | Poor smoke |
| (Petaerythritol | | |
| triacrylate) | | |
| DTMPTA | Poor or no smoke | No smoke |
| (Di(trimethylolpropane) | | |
| triacrylate) | | |

The t-butyl peroxybenzoate initiator did produce a good quality of smoke. The TMPTA+dibutyl phthalate mixture did produce a good quality, albeit sinking, smoke.

### Visible Optical Signatures

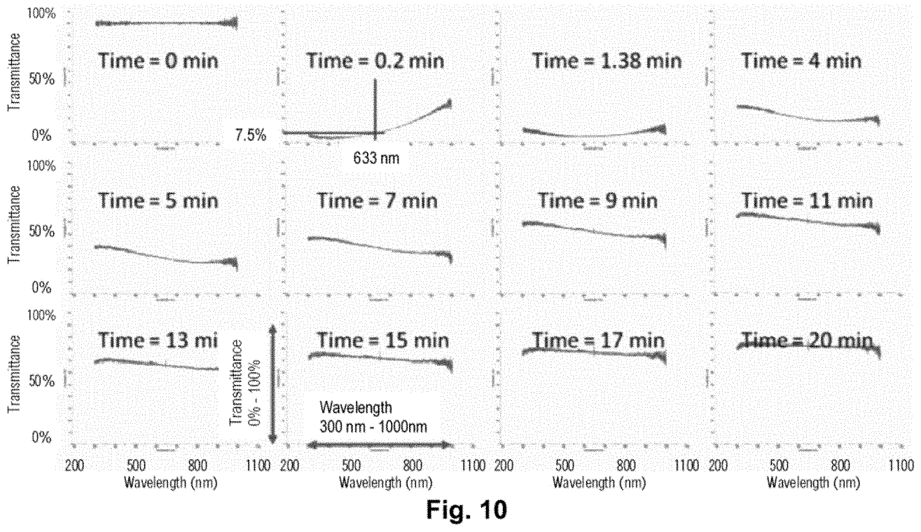

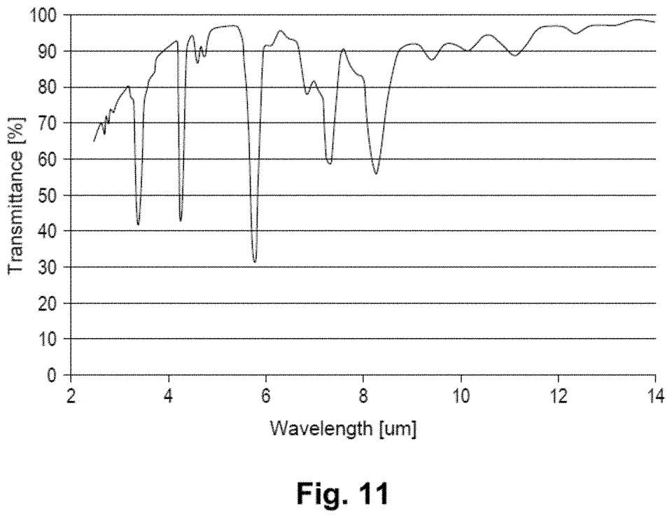

FIG. 10 illustrates the visible absorption spectrum of the smoke produced from the TMPTA-Luperox 231 reaction from the start of the reaction to about 20 minutes after is shown. The data was taken using the one ft3 chamber that was connected to the Ocean Optics spectrometer through flow-ports installed in the back of the chamber. This figure shows that the smoke produced has a uniform absorption across the (entire) visible spectrum from 300-1000 nm. Thus, it evenly scatters all the visible wavelengths. It can also be seen in the figure that the smoke has a persistence of at least 5 minutes. From this data and from other tests this indicates that the particle sizes are in a range where there is not rapid sedimentation of the particles or droplets.

### Infrared Optical Signatures

FIG. 11 illustrates the infrared absorption spectrum of the smoke produced from the TMPTA-Luperox 231 reaction from the start of the reaction to about 9 minutes after the reaction. The data was taken using the 1 ft3 chamber that was connected to the Nexus 470 FTIR system through flow-ports installed in the back of the chamber. The infrared cell has KBr windows. The infrared spectrum has unique peaks associated with the trimethylcyclohexane, t-butyl alcohol, and acetone produced in the reaction. The infrared peak from a human body is centered around 10 The absorption peaks at approximately 6, 7 and 8 μm indicate that the smoke has obscurant properties for 225, 150, and 100° C. bodies.

### Smoke Generator

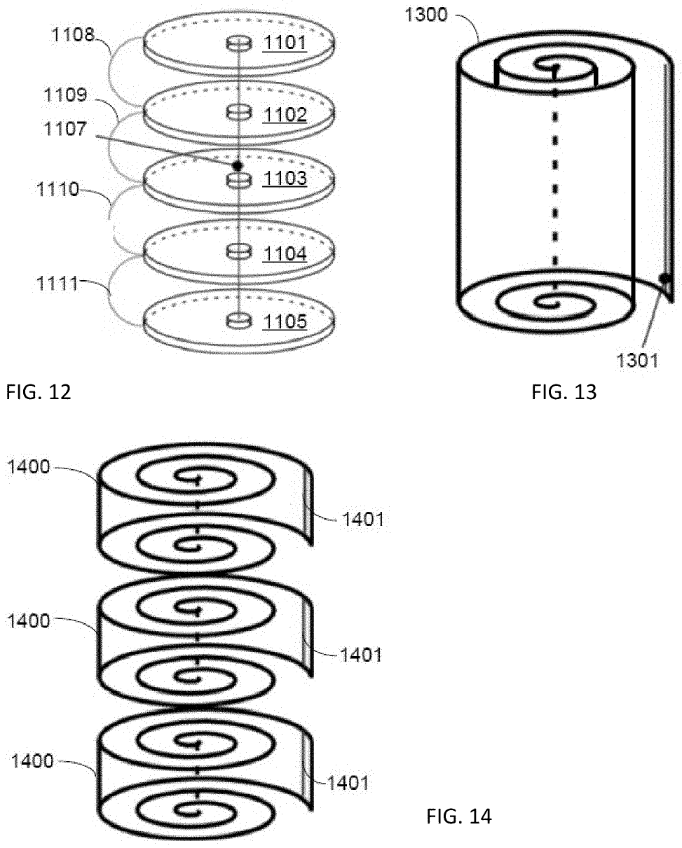

FIG. 12 depicts an embodiment of a smoke generating device 1100 using the compound disclosed herein. In this “stacked disk arrangement,” an embodiment of the smoke generating compound (not shown) is applied to disks 1101, 1102, 1103, 1104 and 1105 stacked atop one another. Although five (5) disks 1101-1105 are shown in FIG. 11, this number of disks is illustrated for explanatory purposes; a smoke generating device 1100 may comprise 10-30 stacked disks, or more, or fewer as desired.

In this embodiment, each disk 1101-1105 is formed from non-woven fiber, such as a plastic fiber similar to Scotch Brite® pads or a plastic Brillo® pad, or fiberglass. The disks 1101-1105 may also be formed from other materials with a high surface area for maximizing the composition's exposure to oxygen during the smoke-producing reaction.

An ignition wire 1106 extends through openings 1107 in the disks 1101-1105 for initiating the reaction. In other embodiments, the ignition wire 1106 may be “woven” into the fiber comprising the disk.

Wires 1108, 1109, 1110, and 1111 extend between adjacent disks. In this regard, wire 1108 extends between disk 1101 and disk 1102; wire 1109 extends between disk 1102 and disk 1103; wire 1110 extends between disk 1103 and disk 1104; wire 1111 extends between disk 1104 and disk 1105.

In some embodiments, insulators (not shown) are disposed between adjacent disks to isolate each disk from the remaining disks, to prevent the disks from sticking together.

FIG. 13 depicts an embodiment of a smoke producing device comprising a substrate 1300 formed from a single sheet of material, rolled into a spiral shape as shown. The substrate 1300 may be formed from the materials discussed above with respect to FIG. 12. An ignition line 1301 extends through the substrate 1300.

FIG. 14 depicts a “stacked spiral” arrangement in which a plurality of spiral substrates 1400 like those discussed above with respect to FIG. 13 are stacked atop one another. Each substrate comprises an ignition line 1401.

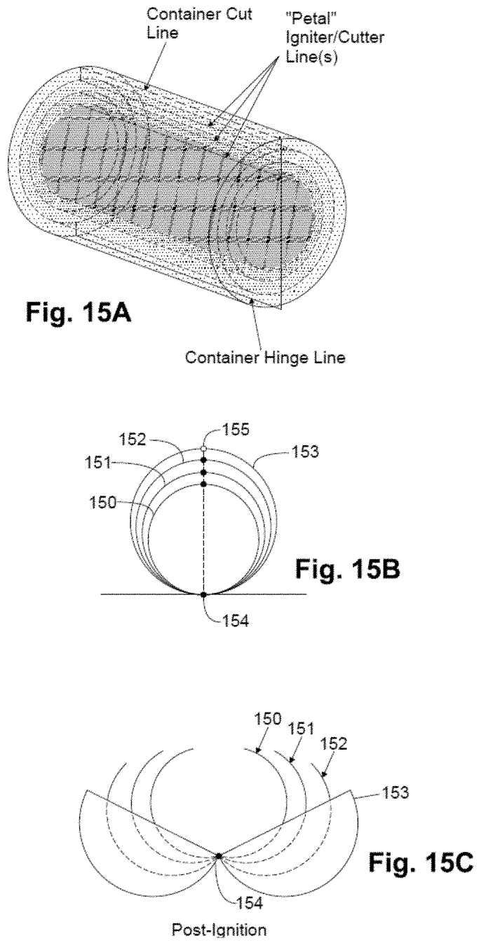

FIGS. 15A, 15B and 15C depict an embodiment of a smoke producing device in which a plurality of cylindrical petals 150, 151 and 152 are nested inside a cylindrical container 153 that is hinged on one side via a hinge 154. FIGS. 15A and 15B depict the container 153 before the smoke producing ignition is initiated, and FIG. 15C depicts the container 153 after the ignition has begun. Although three petals 150, 151, and 152 are depicted in the illustrated embodiment, more or fewer petals are employed in other embodiments.

The ignition sequence causes the container 153 to be split so that it opens up along a hinge line 155 of the container 153. The concentrically arranged petals 150, 151 and 152 are ignited and split along one side so that they “open up” like a blooming flower. Each of the petals 150, 151 and 152 may be formed from the materials discussed with respect to FIG. 12 above.

### Open Field Test

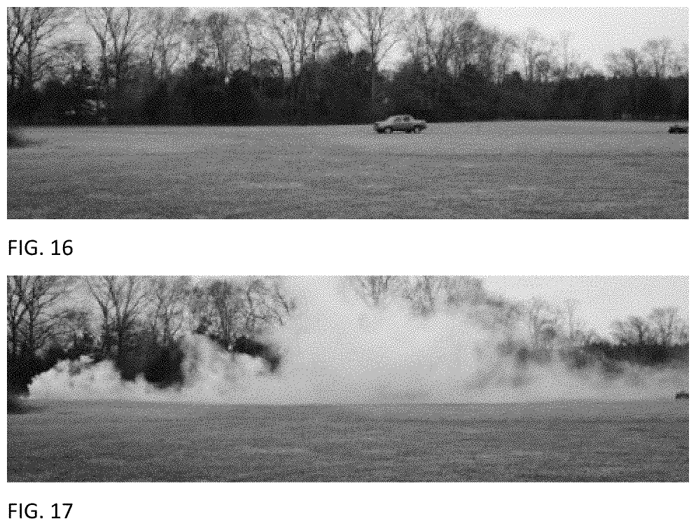

An open field test was performed with an embodiment of the smoke generating composition. A nearby vehicle was used as a landmark by which to judge the quality of the obscurant. FIGS. 16 and 17 show the obscuring quality of the smoke at two time points 90 seconds apart. The photographs show that the vehicle was completely obscured rapidly.

### Police Field Test

Two embodiments of the smoke were observed to have excellent persistence (“staying power”) that is comparable to or better than earlier products. These were tested by local law enforcement. The smokes did not clog the filters in police gas masks during an afternoon of testing. Subjects stated that their filters clog after approximately 5 minutes of exposure to previously used smoke products.

Smoke grenades were activated and set on the floor of a portable home (filled with flammable clutter) and a school bus. There was no damage, ignition, or burn marks on the floor of either location.

The smokes were opaque in the visible spectrum (zero visibility at 1 m), but the subjects reported they could see “perfectly” through the smoke with their thermal imaging devices. The test subjects stated that smoke from TA smoke grenades settles quickly, so users must repeatedly throw additional smoke grenades into buildings to maintain a suitable level of obscurant. During demonstrations, the tested embodiment of the inventive smoke did not settle like TA smoke. In fact, during testing in a house of one tested embodiment of the inventive smoke, the team activated the smoke, performed its evaluations (walked among the various rooms in the house and up and down the stairs to “clear” all the rooms and observe the smoke density), and then had to wait more than ten minutes for the smoke to clear before another test could commence. A subject stated that the density of the smoke was comparable or better than devices currently available.

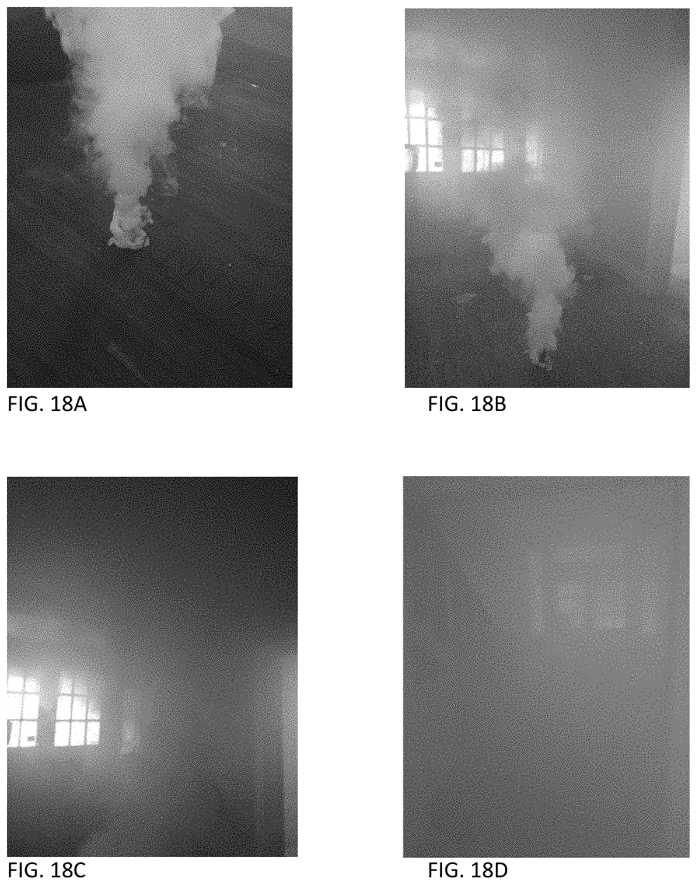

FIGS. 18A-18D show a series of photos taken during a demonstration inside a house. Sixty (60) grams of smoke formulation was placed in a glass container and activated from a 9-volt battery and a Ni-Chrome wire. This is the amount of formulation that would fill one smoke grenade. The smoke remained buoyant for several minutes after activation and created enough smoke to fill the downstairs rooms in the house. These photos were taken with windows in the background to obtain some detail in the images. Photos taken without strong daylight as a background were completely opaque.

Previous testing showed that experimental embodiments of the smoke have very low optical transmission in the ultraviolet (UV) through visible wavebands (300 nm-1000 nm); hence, its exceptional performance as a visual obscurant. In a 5 m3 test chamber using 15 grams of smoke formulation, total obscuration was achieved in less than 60 seconds and persisted well past 30 minutes.

### Flammability Testing

FIG. 18 is a time series of photographs of a field test of an embodiment of the smoke generator in a building. The smoke grenade was set on a wood floor and initiated without damaging the floor. These photos were taken with bright daylight in the background. Photos taken without the light in the background are completely opaque. FIG. 18A was taken at 3 seconds after activation of the smoke generator; 18B at 6 seconds; 18C at 60 seconds; and 18D at 6 minutes.

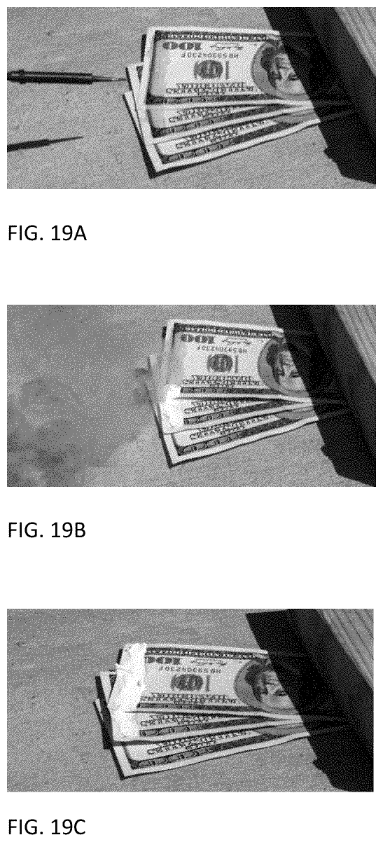

FIG. 19 is a time series demonstrating the generation of smoke using an embodiment of the smoke-generating composition on an inflammable substrate (currency). The composition was applied to the ends of the bills and activated using a soldering iron (FIG. 19A). The chemical reaction produced smoke but did not burn the bills (FIG. 19B). After the reaction is complete, a residue remains which can be brushed aside, leaving the bills unharmed (FIG. 19C).

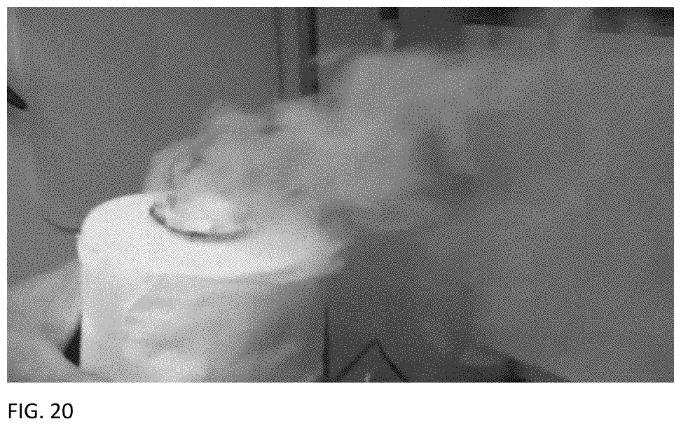

FIG. 20. shows the results of a test in which an embodiment of the smoke generation composition was placed on the cardboard inside a roll of tissue paper and initiated. Smoke was created, but the paper and cardboard remain intact and unburned.

An embodiment of the smoke was tested in a highly flammable environment. The formulation was packed in a thin, metal shell and placed in a pan of gasoline. The formulation was activated successfully and did not ignite the gasoline or its vapors.

A head-to-head comparison was made between an embodiment of the inventive smoke and a commercial smoke developed by Safariland Group, Defense Technologies (“DT”). The tests were performed in an open-air test range, a tear gas facility, and a Safariland chemistry laboratory. The experimental embodiment of the inventive smoke and the commercial DT smoke demonstrated little to no settling, but the experimental embodiment of the inventive smoke outperformed the DT smoke in duration and light absorption (opacity).

In other demonstrations, smoke grenades were activated in a portable home and inside an empty school bus. The home had tile floors, and the school bus had rubber-lined flooring. In both cases, the CoolSmoke grenades were activated and laid on the floors. In neither case were the floors damaged. In addition, the portable home was filled with flammable clutter (papers, boxes, etc.) which was not ignited or damaged during the demonstration.

### Animal Toxicity Testing

The objective of this study was to assess, in mice, gross toxicities associated with exposure to an embodiment of the smoke. The smoke was generated by a chemical reaction between a tri-functional polymer molecule and a benzoic acid base peroxide initiator.

The study design was as follows:

Experimental Design

| | | | Treatment | |
|---|---|---|---|---|
| Group | Name | Treatment | Days | n |
| A | Control | None | N/A | 5 |
| B | Obscurrant | Benzoic acid oligomer; AUM | 1 | 15 |
| | Exposed | ~800-1000 | | |
| | | 5 minute exposure | | |

Experimental Day −5 (Feb. 27, 2018) Animals received at site- acclimation
Experimental Day −1 Baseline Animal weight
Experimental Day 0 Exposure to obscurant
i. Neutralizing wash
Experimental Days 30 Final weight measurement- end in-life phase

Materials and Methods

Test Items

Benzoic acid oligomer; AUM ^{˜}800-1000.

Identification: The chemical reaction to produce the obscurant leads to a reconfiguration and production of obscurant droplets. Mass-spectrometer based data indicates that the molecules produced by the reaction are 4-6 unit oligomers of the initiator used in the reaction.

Physical Description: solid prior to initiation with resistance wire heated to approximately 120° C. by an electrical device (battery).

Concentration: Nominal exposure dose of 1.64 g/m³ [benzoic acid oligomer]

Storage Conditions: N/A.

Animals

Female ICR CD-1 mice (6-7 weeks) obtained from Envigo, Madison, Wis., facility.

Environmental Conditions

Housing Target temperatures of 17° C. to 23° C. with a relative target humidity of 30% to 70% were maintained. A 12-hour light/12-hour dark cycle was maintained, except when interrupted for designated procedures.

Housing

Animals were socially housed (up to 5 animals of the same dosing group together).

Food and Water

Animals were provided with rodent chow and water (municipal tap) ad libitum.

Cage Side Observations

Cage side observations were performed once daily, beginning experimental Day −5. Animals were not removed from cage during observation, unless necessary for identification or confirmation of possible findings. Animals were monitored for general health/mortality and moribundity

Animal Obscurant Exposure

Animals were placed in a plexiglass exposure containment tank (30″×14″×12″) that was essentially airtight. The tank was then set into a chemical fume hood and the obscurant reaction was initiated. The mice were exposed to the obscurant for 5 minutes at an approximate concentration of 1.64 g/m³ benzoic acid oligomer. After 5 minutes the test compound was evacuated from the containment chamber by partially removing the lid of the containment device while still under the chemical fume hood. Obscurant evacuation took approximately 2 minutes.

After the test compound had been evacuated from the chamber, the mice were transported back to the vivarium and individually cleaned with a sodium bicarbonate based neutralizing solution.

Neutralizing Wash Method:

Materials

500 mL wash bottle of 5% sodium bicarbonate solution (neutralizer)

500 mL wash bottle of warm tap water (rinse)

Paper toweling

Clean cages with absorbent wipers

The mice were removed from the exposure containment tank into a clean polycarbonate cage lined with absorbent pads. Each mouse was restrained, by its tail, in a vertical position over the absorbent pads and sprayed with copious amounts of the 5% sodium bicarbonate solution before being placed into a second clean cage with absorbent pads.

The process was repeated with warm tap water, ending with mice being placed in a clean dry cage lined with absorbent pads.

The mice were then individually dried with paper toweling as they were returned to their home cage.

Control animals were placed in the tank for the same amount of time without exposure to the obscurant and subsequently cleaned with the neutralizing solution.

### Sample Collection and Analysis

No samples were collected for this study. Animal weights were determined every 24 hours for the first 48 hours after exposure followed by bi-weekly weight determinations for the remainder of the study.

### Results

### Cage Side Observations

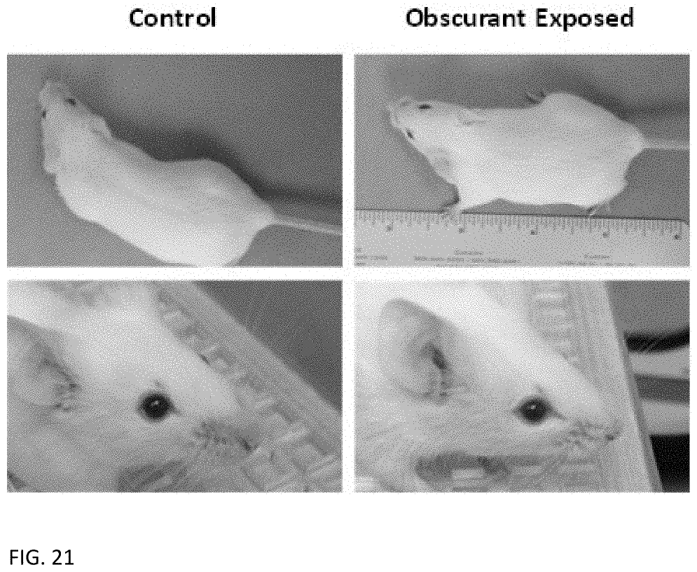

During the course of the study no observation of note were made for either control or obscurant exposed animals. Specifically, no changes in grooming behavior, social interactions or feeding behavior were observed. Additionally, there were no indications of anaphylaxis, skin or ocular irritation or inflammation. Images of representative mice from the taken 30 days after exposure are presented in FIG. 21.

### Animal Weight

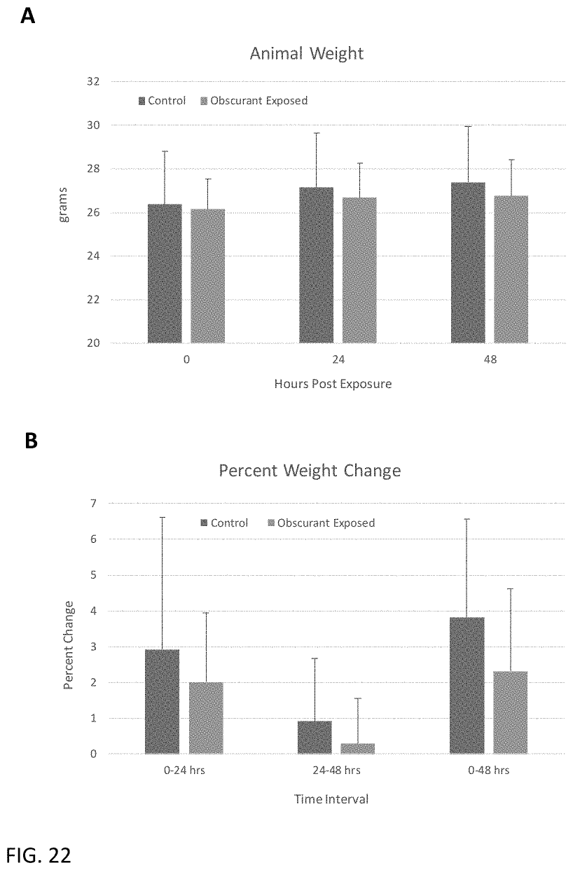

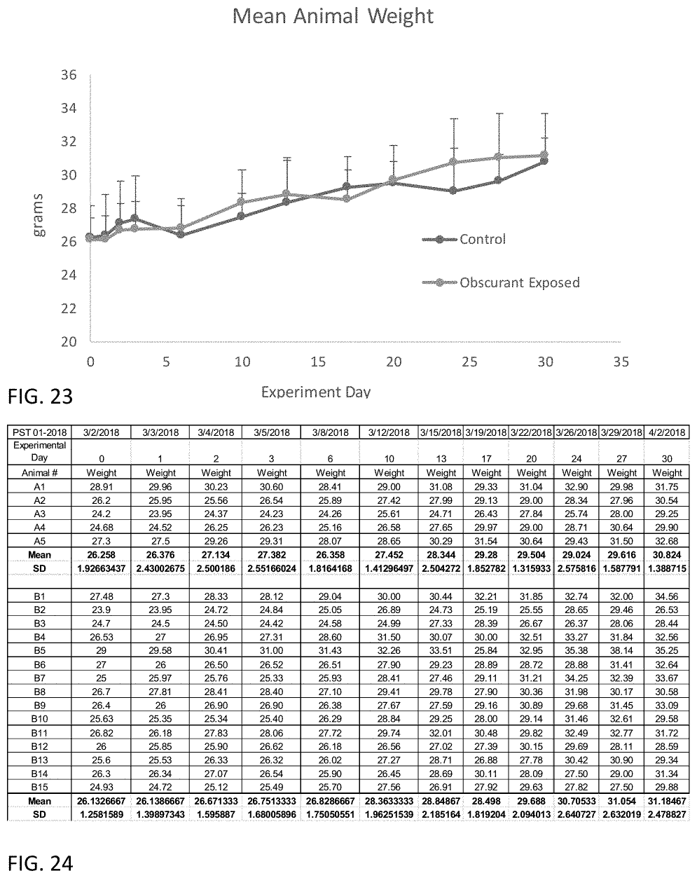

Animal weights were determined daily for the first two weeks of the study and bi-weekly thereafter. There were no significant differences in mean animal weight immediately after exposure (FIG. 22) and neither the control or obscurant exposed animals lost weight. Additionally, there were no differences over the course of the entire study (FIG. 23). Differences between groups were assessed using Students T-test. All the raw data that were collected is presented in FIG. 24.

### SUMMARY

A group of female ICR mice were submitted to a 5-minute exposure in a tank containing a nominal concentration of a novel cool-smoke obscurant that was generated by a chemical reaction between a tri-functional polymer molecule and a benzoic acid base peroxide initiator. Over the course of 30 days following exposure the mice were monitored for gross signs of toxicity and animal weights were determined on a bi-weekly basis. The results of the study indicated that there were no obvious signs of acute toxicity in the obscurant exposed mice. In comparison to non-exposed controls there were no significant changes animal weights of the exposed animals over the 30-day study period.

### Thermal Stability and Initiation Testing

### Introduction

A series of tests was performed to determine 1) the 1-hour thermal stability of an embodiment of the smoke generating composition, and 2) the heat-source temperature required to initiate the FPR for the production of obscurant.

### Experimental

Two types of tests were run. One set involved testing the thermal stability of the smoke generating material for an extended duration (1 hour) at elevated temperatures. These temperatures were 60° C., 70° C., and 80° C. The second test was to determine the temperature of the “hot spot” that is necessary to initiate the FPR.

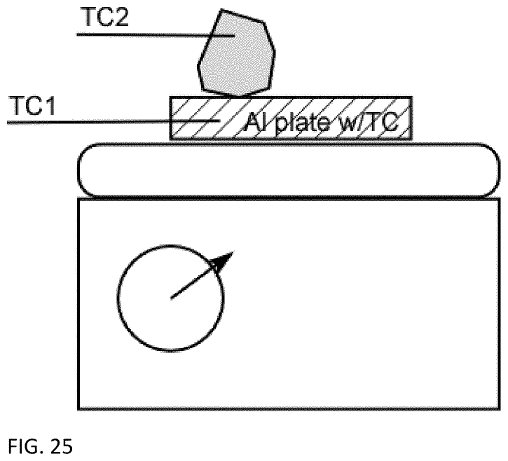

The experimental setup is shown in FIG. 25. It consists of a temperature-controlled hot-plate, a ¼″ aluminum plate, and smoke-generation composition samples. Type K thermocouples were inserted into the Al plate and into the smoke-generation composition gel. Approximately 10 grams of gel were used for these tests. The Al plate had a hole drilled into it so that the Al-plate-thermocouple was in approximately below the gel.

The thermal stability tests were performed by leaving the smoke-generation composition gel on the hotplate for an hour at the specified temperatures. Either the reaction started or it did not. For ease of reference this test is referred to as “Aluminum Plate Thermal Stability Test.” Any claims to thermal stability that cannot otherwise be construed with reasonable certainty should be assumed to refer to thermal stability as measured by this Aluminum Plate Thermal Stability Test.

The thermal start, or heat-source temperature required to start the reaction, was tested by allowing the Al plate to come to the starting temperature and then turning the hotplate temperature up to its maximum power input; this is the time when the time versus temperature data acquisition started. The temperatures of the Al plate and the smoke-generation composition gel were recorded independently. Once the FPR started, the hotplate was turned off. Data were recorded for 300-500 seconds. For ease of reference this test is referred to as “Aluminum Plate Temperature Test.” Any claims to temperature of the FPR that cannot otherwise be construed with reasonable certainty should be assumed to refer to temperature as measured by this Aluminum Plate Temperature Test.

### Results

The tested embodiment of the smoke-generation composition gel was thermally stable (1-hour duration) for the 60° C.-80° C. tests performed. 80° C. was the maximum temperature used in this series of tests.

The hot-spot temperature required to initiate the FPR was approximately 129° C.

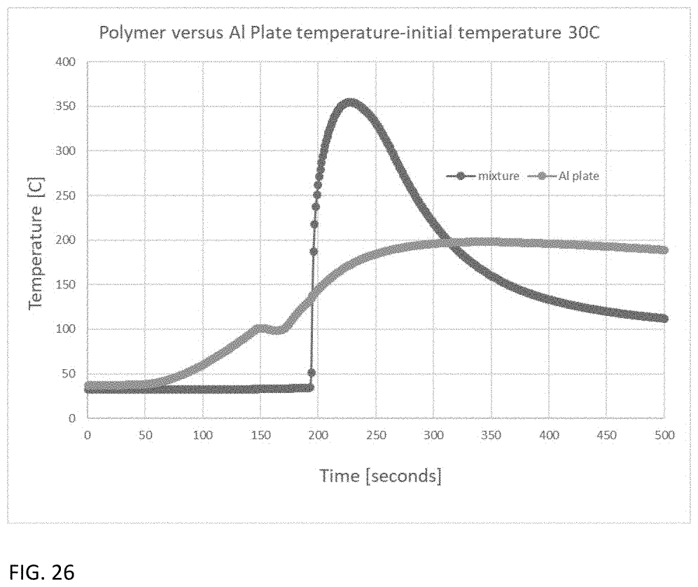

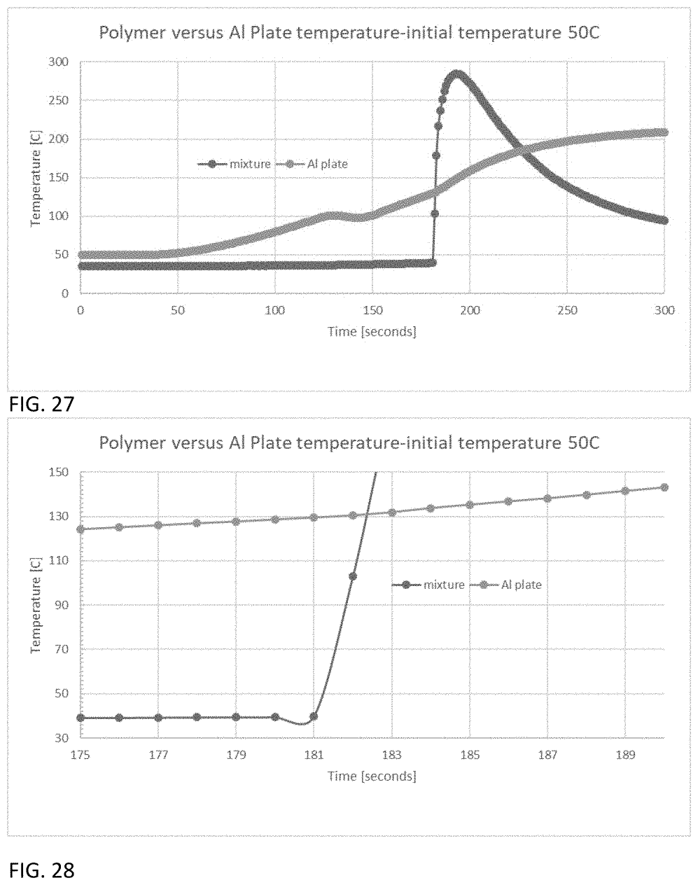

FIGS. 26-28 are temperature versus time plots that include the measured temperature of the Al plate and the smoke-generation composition. After the hotplate (temperature) power input is turned to its maximum, the temperature of the aluminum plate increases. There is a slight decrease in the temperature around 100° C. that indicates the final vaporization of residual water in the gel. At an Al plate temperature of about 129° C. the FPR starts, and then proceeds rapidly. FIG. 26 shows the temperature versus time plots for a starting Al plate temperature of 30° C. FIG. 27 shows a starting Al plate temperature of 50° C. FIG. 28 is an expanded view of the temperature versus time for a 50° C. starting temperature. From FIG. 28 it is relatively clear to see the temperature necessary for reaction initiation. Note that the reaction start itself has an endothermic characteristic before the exothermal FPR overwhelms the system. No difference was found between the required heat source temperature to start the reaction between samples maintained at 30° C. and 50° C.

### VII. EXEMPLARY EMBODIMENTS

The following are non-limiting examples of specific embodiments of the subject matter disclosed above. This disclosure specifically but non-exclusively supports claims to these embodiments:

Embodiment 1. A composition for the flameless generation of smoke, the composition comprising:
(a) a monomer compound that exothermically polymerizes upon initiation with t-butyl peroxybenzoate, wherein the polymerization of the monomer compound is exothermic;
(b) t-butyl peroxybenzoate at a mass concentration that is 5% or more of the mass concentration of the monomer compound; and
(c) a filler agent in a sufficient amount to permit a frontal polymerization reaction to propagate in the composition once polymerization has been initiated.
   Embodiment 2. The composition of embodiment 1, wherein the mass concentration of the t-butyl peroxybenzoate is at least 10% of the mass concentration of the monomer fraction.
   Embodiment 3. The composition of embodiment 1, wherein the mass concentration of the t-butyl peroxybenzoate is at least 100% of the mass concentration of the monomer fraction.
   Embodiment 4. The composition of embodiment 1, wherein the mass concentration of t-butyl peroxybenzoate is less than twenty times the mass concentration of the monomer fraction.
   Embodiment 5. The composition of embodiment 1, wherein the monomer fraction consists of the monomer compound.
   Embodiment 6. The composition of embodiment 1, wherein the monomer fraction comprises multiple monomer compounds.
   Embodiment 7. The composition of embodiment 1, wherein the monomer compound is a trifunctional monomer having three double-bond carbon ends.
   Embodiment 8. The composition of embodiment 1, wherein the monomer compound is a triacrylate monomer.
   Embodiment 9. The composition of embodiment 1, wherein the monomer compound is selected from one or both of: glycerol propoxylate (1-PO/OH) triacrylate (GPOTA) and trimethylpropane propoxylate triacrylate (TMP(PO)TA).
   Embodiment 10. The composition of embodiment 1, wherein the monomer compound is trimethylolpropane triacrylate (TMPTA).
   Embodiment 11. The composition of embodiment 1, wherein the filler agent is fumed silica.
   Embodiment 12. The composition of embodiment 1, wherein the filler agent is fumed silica at a mass concentration that is 10% or more of the mass concentration of the monomer compound.
   Embodiment 13. The composition of embodiment 1, comprising an infrared-opaque agent.
   Embodiment 14. The composition of embodiment 1, comprising an infrared-opaque agent selected from the group consisting of: methyl benzoate, benzyl benzoate, and pentyl acetate.
   Embodiment 15. The composition of embodiment 1, wherein the composition does not contain a significant amount of inorganic oxidizer.
   Embodiment 16. The composition of embodiment 1, wherein the composition does not contain a significant amount of any of a chlorate, perchlorate, nitrate, sulfate, permanganate, chromate, an inorganic peroxide, and an inorganic oxide.
   Embodiment 17. The composition of embodiment 1, comprising a flameless heat source to activate the initiator compound.
   Embodiment 18. The composition of embodiment 1, wherein the monomer compound will neither self-initiate nor self-polymerize with t-butyl peroxybenzoate.
   Embodiment 19. The composition of embodiment 1, supported by a fibrous matrix to support the composition.
   Embodiment 20. The composition of embodiment 1, wherein the frontal polymerization reaction requires an initiation temperature of 120-140° C.
   Embodiment 21. The composition of embodiment 1, wherein the composition is a generally flat sheet or strip, and wherein the composition reaches a maximum temperature of no more than 400° C. during the FPR.
   Embodiment 22. The composition of embodiment 1, wherein the composition is a generally flat sheet or strip, and wherein the composition reaches a maximum temperature of no more than 300° C. during the FPR.
   Embodiment 23. The composition of embodiment 1, wherein polymerization of the monomer in the presence of the initiator produces smoke in the absence of flame.
   Embodiment 24. A non-pyrotechnic method of generating smoke, the method comprising: initiating an FPR in the composition of embodiment 1, and generating smoke non-pyrotechnically.
   Embodiment 25. A smoke is provided that is the product of the method of embodiment 24, the smoke comprising a decomposition product of an initiator compound.
   Embodiment 26. A non-pyrotechnic smoke generator for generating a smoke, said smoke generator comprising: a support member; the composition of the first aspect supported by the support member; and a means to initiate polymerization of the monomer with the initiator; wherein the composition generates smoke via a frontal polymerization reaction once initiated.

### VIII. CONCLUSIONS

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description and accompanying drawings illustrate and describe certain processes, machines, manufactures, and compositions of matter, some of which embody the invention(s). Such descriptions or illustrations are not intended to limit the scope of what can be claimed, and are provided as aids in understanding the claims, enabling the making and use of what is claimed, and teaching the best mode of use of the invention(s). If this description and accompanying drawings are interpreted to disclose only a certain embodiment or embodiments, it shall not be construed to limit what can be claimed to that embodiment or embodiments. Any examples or embodiments of the invention described herein are not intended to indicate that what is claimed must be coextensive with such examples or embodiments. Where it is stated that the invention(s) or embodiments thereof achieve one or more objectives, it is not intended to limit what can be claimed to versions capable of achieving all such objectives. Any statements in this description criticizing the prior art are not intended to limit what is claimed to exclude any aspects of the prior art.

Additionally, the disclosure shows and describes certain embodiments of the processes, machines, manufactures, compositions of matter, and other teachings disclosed, but it is to be understood that the teachings of the present disclosure are capable of use in various other combinations, modifications, and environments and is capable of changes or modifications within the scope of the teachings as expressed herein.

Any section headings herein are provided only for consistency with the suggestions of 37 C.F.R. § 1.77 or otherwise to provide organizational queues. These headings shall not limit or characterize the invention(s) set forth herein.

1. (canceled)

2. A composition for the flameless generation of smoke, the composition comprising:
(a) a monomer compound that exothermically polymerizes upon initiation with t-butyl peroxybenzoate, wherein the polymerization of the monomer compound is exothermic;
(b) t-butyl peroxybenzoate at a mass concentration that is 5% or more of the mass concentration of the monomer compound; and
(c) a filler agent in a sufficient amount to permit a frontal polymerization reaction to propagate in the composition once polymerization has been initiated.

3. The composition of claim 2, wherein the mass concentration of the t-butyl peroxybenzoate is at least 10% of the mass concentration of the monomer compound.

4. The composition of claim 2, wherein the mass concentration of the t-butyl peroxybenzoate is at least 100% of the mass concentration of the monomer compound.

5. The composition of claim 2, wherein the mass concentration of t-butyl peroxybenzoate is less than twenty times the mass concentration of the monomer compound.

6. The composition of claim 2, comprising a monomer fraction that consists of the monomer compound.

7. The composition of claim 2, comprising a monomer fraction that comprises multiple monomer compounds.

8. The composition of claim 2, wherein the monomer compound is a trifunctional monomer having three double-bond carbon ends.

9. The composition of claim 2, wherein the monomer compound is a triacrylate monomer.

10. The composition of claim 2, wherein the monomer compound is selected from one or both of: glycerol propoxylate (1-PO/OH) triacrylate (GPOTA) and trimethylpropane propoxylate triacrylate (TMP(PO)TA).

11. The composition of claim 2, wherein the monomer compound is trimethylolpropane triacrylate (TMPTA).

12. The composition of claim 2, wherein the filler agent is fumed silica.

13. The composition of claim 2, wherein the filler agent is fumed silica at a mass concentration that is 10% or more of the mass concentration of the monomer compound.

14. The composition of claim 2, comprising an infrared-opaque agent.

15. The composition of claim 2, comprising an infrared-opaque agent selected from the group consisting of methyl benzoate, benzyl benzoate, and pentyl acetate.

16. The composition of claim 2, wherein the composition does not contain a significant amount of inorganic oxidizer.

17. The composition of claim 2, wherein the composition does not contain a significant amount of any of a chlorate, perchlorate, nitrate, sulfate, permanganate, chromate, an inorganic peroxide, and an inorganic oxide.

18. The composition of claim 2, comprising a flameless heat source to activate the initiator compound.

19. The composition of claim 2, wherein the monomer compound will neither self-initiate nor self-polymerize with t-butyl peroxybenzoate.

20. The composition of claim 2, supported by a fibrous matrix to support the composition.

21. The composition of claim 2, wherein the frontal polymerization reaction requires an initiation temperature of 120-140° C.

22. The composition of claim 2, wherein the aluminum plate reaches a maximum temperature of no more than 400° C. during the FPR as measured by the Aluminum Plate Temperature Test.

23. The composition of claim 2, wherein the aluminum plate reaches a maximum temperature of no more than 300° C. during the FPR as measured by the Aluminum Plate Temperature Test with a starting temperature of 30° C.

24. The composition of claim 2, wherein the aluminum plate reaches a maximum temperature of no more than 200° C. during the FPR as measured by the Aluminum Plate Temperature Test with a starting temperature of 30° C.

25. The composition of claim 2, wherein the composition reaches a maximum temperature of no more than 400° C. during the FPR as measured by the Aluminum Plate Temperature Test with a starting temperature of 30° C.

26. The composition of claim 2, wherein polymerization of the monomer in the presence of the initiator produces smoke in the absence of flame.

27. The composition of claim 2, wherein the composition will not ignite paper when in contact with the paper during the FPR.
